(19) United States
(12) Patent Application Publication
(10) Pub. No.: US 2026/0241437 A1
(43) Pub. Date: Aug. 20, 2026

(54) EQUIPMENT AND PROCESSES FOR SHEET METAL CONSOLIDATION

(71) Applicant: MASSACHUSETTS INSTITUTE OF TECHNOLOGY, Cambridge, MA (US)

(72) Inventors: Onur GUVENC, Cambridge, MA (US); Cemal Cem TASAN, Cambridge, MA (US); Lucas N. MARDEN, Boston, MA (US)

(21) Appl. No.: 18/998,845

(22) PCT Filed: Aug. 23, 2023
(86) PCT No.: PCT/US2023/072712

§ 371 Date: Jan. 27, 2025

Related U.S. Application Data
(60) Provisional application No. 63/400,197, filed on Aug. 23, 2022.

(51) Int. Cl. B21D 51/10; B30B 9/32

(52) U.S. Cl. CPC B21D 51/10; B30B 9/32

(57) ABSTRACT

Methods for consolidating scrap metal into a sheet metal for subsequent use are disclosed. The methods can include forming a container, such as a pipe or tube, out of a sheet metal such that one end of the container is closed and the other is open. The scrap metal can then be placed into the container, even without pre-treating the scrap metal. Oxygen can be removed from an internal, receiving cavity of the formed container, such as by introducing a gas such as argon or nitrogen, into the container, and, if desired, the open end of the container can be sealed. The combination of the container made from the sheet metal and the scrap metal can be roll bonded to form a consolidated sheet metal that includes both the original sheet metal and the scrap metal. Systems for performing these methods, as well as the consolidated metal, are also described.

### CROSS REFERENCE TO RELATED APPLICATION

The present disclosure claims priority to U.S. Provisional Application No. 63/400,197, entitled “Equipment and Processes for Sheet Metal Consolidation,” which was filed on Aug. 23, 2022, and which is incorporated by reference herein in its entirety.

### FIELD

The present disclosure relates to systems and methods for reclaiming scrap metal, and more particularly relates to new roll bonding processes used to consolidate scrap metal.

### BACKGROUND

The manufacturing of metal components, such as processes used in ironmaking, steelmaking, and metal forming is fraught with drawbacks. These include high amounts of energy used in conjunction with the manufacturing processes, environmentally unfriendly materials released into the air in conjunction with the same (e.g., CO, CO₂, SOx, NOx, etc. emissions), the creation of wastewater contaminants, hazardous wastes, and/or other solid wastes, as well as the high costs—from a dollars and an energy perspective—associated with the same.

In recent years, alternative technologies have been proposed to either mitigate CO₂ emissions while retaining coal as the reduction agent (i.e., CO₂ management) or displace carbon to avoid the generation of CO₂—and other negative effects—in the first place (i.e., CO₂ direct avoidance). In the CO₂ management direction, technological advances focus on utilizing CO₂ in steelmaking for enhanced oil recovery (EOR) or as a chemical feedstock either directly or through lime production. For the cases in which CO₂ utilization is not feasible, the subsurface storage is investigated as well. In the CO₂ direct avoidance direction, the advances are more ambitious, but reside in the early development phase. Further, the application of hydrogen in various stages of steel production, from ironmaking to coke-free smelting, recycling, or ancillary processes, has been investigated extensively. Besides the hydrogen route, decarbonization efforts based on the reduction of iron ore without CO₂ emissions have gained attention, such as molten oxide electrolysis, ammonia-assisted molten oxide reduction, molten salt electrolysis, molten salt reduction with water at high temperatures, and electrowinning iron near room temperature using alkaline solutions to name a few. Despite these routes promising a disruptive reduction in CO₂ emissions, they use iron ore as the input material and do not displace iron ore extraction for steel production.

The scrap metal that results from the manufacturing processes described above, and produced in other contexts, is often discarded as it is often not suitable for reuse. Even to the extent that attempts have been made to recycle and/or reuse scrap metal, similar drawbacks exist with the processes used in conjunction with the same. For example, in some cases, it is possible to utilize scrapped metal in the solid state for new applications through direct-reuse or after a resizing operation. Although both utilization methods skip the entire process chain and have minimal energy and CO₂ burden, they can be applied to only metal scrap with specific size requirements. To overcome this challenge, various processing methodologies allowing for the reforming of scrap metal components are proposed.

Another example of a popular technique for combining different metals together to form a composite is roll bonding. Roll bonding is a scalable metal bonding technique commonly used for niche composite applications to achieve material properties unattainable by monolithic alloy design. It generally entails inputting two different metals into opposed rollers, which then roll and press the two different metals together to output a roll-bonded metal sheet. Roll bonding is traditionally used for combining different metals to achieve attributes that cannot be achieved by a single metal, including particular technical properties (e.g., enhanced strength and/or durability), economical properties (e.g., cost savings), and/or societal properties (e.g., lower carbon footprint, and thus better impact on the environment).

While roll bonding itself is not a new manufacturing technique, it is not a technique that has been implemented to consolidate scrap metal. This is the case for a number of reasons. Typically scrap metal comes in random pieces, having different sizes, shapes, textures, etc. Traditional roll bonding techniques, however, utilize rolling mills designed to press sheet metal together. Further, a high amount of variance of certain properties across different scrap metal parts, such as surface quality, can also make it difficult for traditional roll bonding techniques to be effective with scrap metal. Still further, typically a reduced atmosphere can be required to use existing roll bonding techniques, but that atmosphere can be difficult to obtain based, at least in part, on the requirements of such roll bonding techniques. Additionally, two other complications with traditional roll bonding techniques are the techniques typically involve a demanding mechanical input (i.e., more than 50% thickness reduction is a reported industry standard) and there is a low formability of imperfectly bonded metal with such techniques. Also, reutilizing scrapped metal parts in the solid state causes the size of the parts to decrease with each additional processing step, which reduces the possible options for multiple lifecycles even embodied in different products.

To overcome this problem, powder metallurgy and joining-by-forming techniques can be applied to consolidate the metal scrap into a unified form without melting and using less energy: spark plasma sintering, pulsed electric current and hot pressing, and ball milling and sintering are common techniques employed in powder metallurgy. Additionally, hot extrusion of scrapped aluminum pieces to form a uniform billet is a major research topic in this field, with other severe plastic deformation processes such as friction stir extrusion, friction stir consolidation, equal-channel angular pressing, high-pressure torsion, cyclic extrusion compression, and forging being investigated.

Accordingly, there is a need for improved equipment and techniques for being able to re-purpose metal scraps, as well as a need for improved roll bonding techniques that can be used in conjunction with re-purposing metal scraps.

### SUMMARY

The present disclosure provides for systems and methods that enable scrap metal to be repurposed, recycled, reused, reprocessed, and/or otherwise consolidated (also able to be referred to as reconsolidated) by being formed into a useable metal, such as a sheet metal. The techniques directed to allowing for more consolidating of scrap metal are tied, at least in part, to an improved roll bonding method that is robust and scalable for production at the highest and largest levels. The techniques include forming a metal tube and then depositing scrap metal into the formed tube. The formed tube having scrap metal disposed therein is then pressed between a plurality of rollers to roll bond the metal tube and scrap metal together into a consolidated sheet metal.

In comparison to existing roll bonding techniques, besides being able to be used effectively to consolidate scrap metals, the equipment and techniques of the present disclosure lower a thickness reduction to below 50%, lower a processing temperature to about 700° C. or more (e.g., the disclosed methods work on steels at about 700° C. or more), while also having an easy-to-obtain reduced atmosphere, lowering energy requirements, and decreasing the CO₂ burden as a continuous process. The output of the systems and methods employed herein can include a semi-finished product, i.e., the sheet metal comprised of the formed metal tube and scrap metal, that can be further formed into one or more shapes. The techniques and related equipment provided for in the present disclosure allow for scrap metal to be reprocessed using less energy, creating less waste and emissions, and more cheaply than known methods for reprocessing scrap metal. It allows for metal scraps that were previously considered waste to be used in fabrication downstream by becoming part of a consolidated sheet metal.

One method of manufacturing includes configuring sheet metal into a container having an open or closed first terminal end and a second open terminal end, with a receiving cavity formed between the two ends and placing scrap metal in the receiving cavity of the container such that the scrap metal is disposed in the container. The method also includes feeding the container having the scrap metal disposed in it towards a plurality of rolls and operating the plurality of rolls to roll bond the sheet metal of the container and the scrap metal into a consolidated metal sheet.

The method can further include heating at least one of the scrap metal, the sheet metal, or the plurality of rolls prior to and/or during operation of the plurality of rolls to a temperature to roll bond the sheet metal of the container and the scrap into a consolidated metal sheet and maintaining the temperature for a time period that is in approximately a range of about one minute to about one hour. By way of non-limiting examples, the temperature can be at least about 700° C.

In some embodiments the method can include introducing a gas to the receiving cavity of the container. The gas can include argon, nitrogen, and/or other one or more other non-oxygen gases. The method can also include sealing the second open terminal end prior to feeding the container having the scrap metal disposed in it into the plurality of rolls.

The action of configuring sheet metal into a container can further include performing a spiral-formed manufacturing process. Alternatively, the action of configuring sheet metal into a container can further include performing a longitudinal manufacturing process. The method can also include measuring compactness of scrap metal and/or the container having the scrap metal disposed in it prior to feeding the container having the scrap metal disposed in it into the plurality of rolls. Still further, the method can include finishing the consolidated metal sheet, for example by cold forming, flattening, and/or providing a surface treatment.

The container can include a pipe. In some embodiments, the method can further include storing the scrap metal prior to placing the scrap metal in the receiving cavity of the container. Still further, in some embodiments, the method can include at least one of mechanically and/or chemically cleaning at least one of the scrap metal and/or the container prior to placing the scrap metal in the receiving cavity of the container.

The provided disclosures allow for a consolidated metal sheet to be formed using any of the techniques described above and/or elsewhere below.

One system for consolidating scrap metal includes a container formation portion, a scrap metal adding portion, and a roll bonding portion. The container formation portion is configured to produce a container from a sheet metal, with the container having an open or closed first terminal end and a second open terminal end, with a receiving cavity formed between the two terminal ends. The scrap metal adding portion is configured to add scrap metal into the receiving cavity of the formed container. The roll bonding portion is configured to roll bond the scrap metal with the formed container using a plurality of rollers.

In some embodiments the system can include a heater that can be configured to heat the scrap metal, the sheet metal, and/or the plurality of rollers. The system can also include a gas injector that can be configured to introduce gas into the receiving cavity of the formed container. The container formation portion can include a coil of the sheet metal. In some such embodiments, the container formation portion can be configured to operate as a spiral-formed manufacturing process. Alternatively, in some embodiments, the container formation portion can be configured to operate as a longitudinal manufacturing process.

The provided disclosures allow for a system that can perform any of the methods or techniques described above and/or elsewhere below.

### BRIEF DESCRIPTION OF THE DRAWINGS

This disclosure will be more fully understood from the following detailed description taken in conjunction with the accompanying drawings, in which:

FIG. 1A is a schematic view of a prior art primary steel processing method that transforms iron ore into commercial steel through a series of metallurgical treatments;

FIG. 1B is a schematic view of a prior art secondary steel processing method that carries steel scrap through a series of metallurgical treatments;

FIG. 2A is a schematic side view of one exemplary embodiment of a system for roll bonding scrap metal;

FIG. 2B is a cross-sectional front view of two portions of the system taken along lines A-A and B-B, respectively;

FIG. 2C is a schematic flowchart of one exemplary embodiment of a method for roll bonding scrap metal using the system of FIG. 2A;

FIG. 2D is one embodiment of a system for forming a pipe that can be used or otherwise adapted for use with the system of FIG. 2A;

FIG. 3A is a schematic side view of another exemplary embodiment of a system for roll bonding scrap metal;

FIG. 3B is a cross-sectional front view of two portions of the system taken along lines A′-A′ and B′-B′, respectively;

FIG. 3C is a schematic flowchart of one exemplary embodiment of a method for roll bonding scrap metal using the system of FIG. 3A;

FIG. 3D is one embodiment of a system for forming a pipe that can be used or otherwise adapted for use with the system of FIG. 3A;

FIG. 4 is a graphical illustration of a roll bonding processing map for mild steel and stainless steel measuring thickness reduction and hot rolling temperature;

FIG. 5A is a graphical illustration of a formability response of roll bonded samples under equibiaxial tension along with the response of monolithic sample as a reference;

FIG. 5B is a schematic illustration of a test for evaluating the formability of a sheet metal;

FIG. 5C is a table illustrating a crosshead height at fracture of each sample of FIG. 5A; and

FIG. 6 is an example embodiment of the system for roll bonding scrap metal of FIG. 2A installed and operated in a shipping container.

### DETAILED DESCRIPTION

Certain exemplary embodiments will now be described to provide an overall understanding of the principles of the structure, function, manufacture, and use of the systems, devices, and methods disclosed herein. One or more examples of these embodiments are illustrated in the accompanying drawings. Those skilled in the art will understand that the systems, devices, and methods specifically described herein and illustrated in the accompanying drawings are non-limiting exemplary embodiments and that the scope of the present disclosure is defined solely by the claims. The features illustrated or described in connection with one exemplary embodiment may be combined with the features of other embodiments. Such modifications and variations are intended to be included within the scope of the present disclosure. In the present disclosure, like-numbered components of various embodiments generally have similar features when those components are of a similar nature and/or serve a similar purpose, unless otherwise noted or otherwise understood by a person skilled in the art.

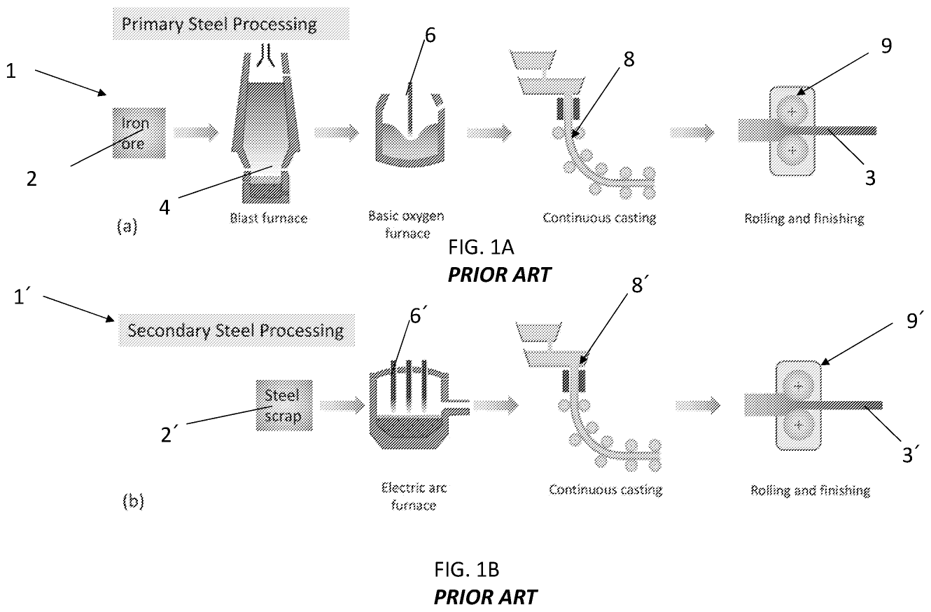

Steel processing can be classified into two main pathways, as shown in FIGS. 1A-1B. About 73% of the world's steel is processed by a primary steel processing technique 1 illustrated in FIG. 1A. As shown, iron ore 2 can be transformed into commercial steel 3 through a series of metallurgical processes, including being introduced into a blast furnace (BF) 4 and a basic oxygen furnace (BOF) 6 in a molten state, followed by continuous casting (CC) 8 and hot rolling (HR) 9 in solid form to produce the commercial steel 3. FIG. 1B illustrates a secondary steel processing route 1′, in which collected and sorted steel scrap 2′ can be recycled by melting and treating it in an electric arc furnace (EAF) 6′, followed by continuous casting (CC) 8′ and hot rolling (HR) 9′ in solid form to produce commercial steel 3′.

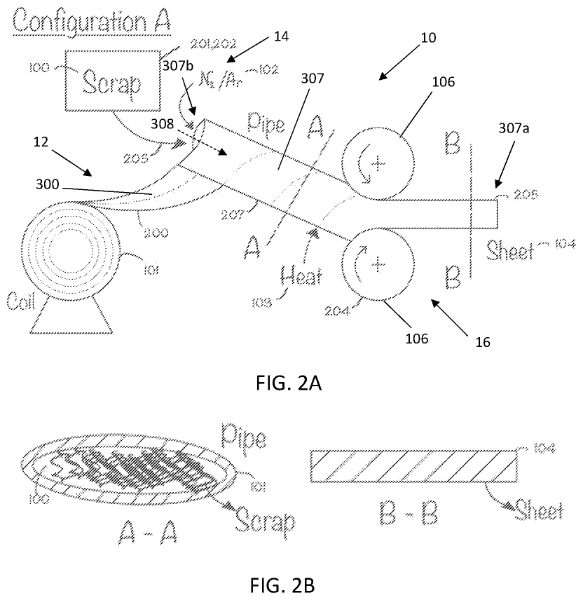

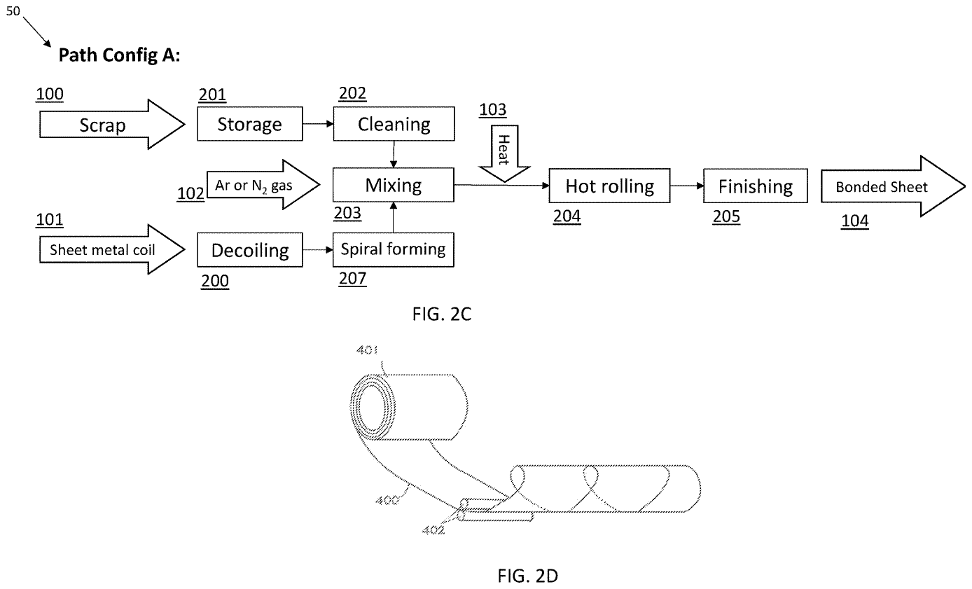

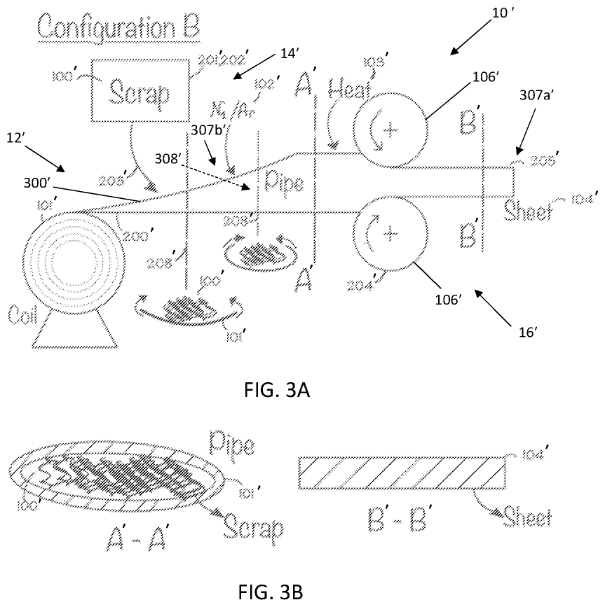

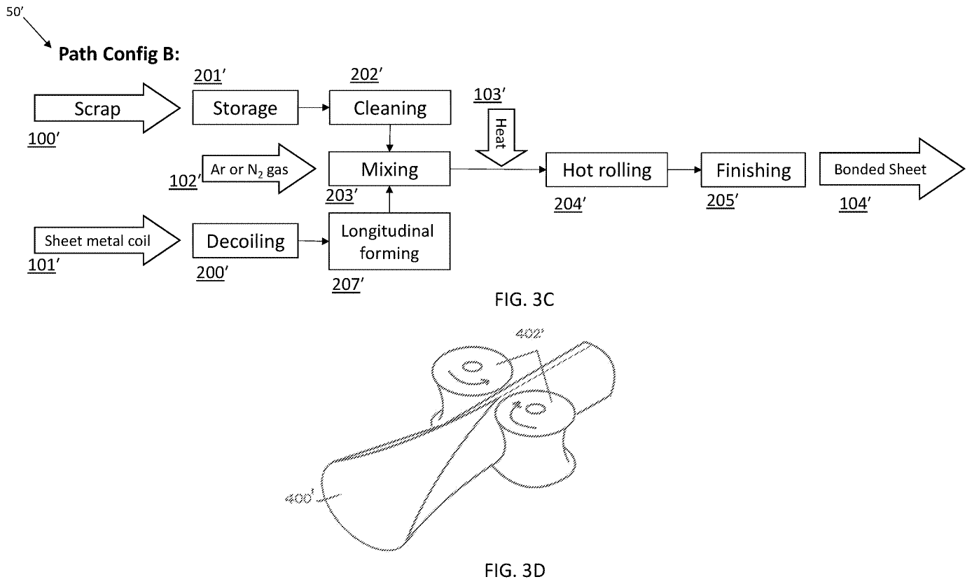

In some embodiments, sheet metal scrap can be consolidated by (1) pre-heating to a rolling temperature TRB, (2) applying plastic deformation by hot rolling at a reduction degree % R encapsulated by an outer support layer, and (3) continuously post-annealing to allow for the realignment of the bond structure at the interfaces. The total energy demand of scrap metal consolidation (E_{SMC}) can be equal to the summation of the energy demand of pre-heating (E_{PRH}), roll bonding (E_{RB}), and post-heating (E_{POH}). The present disclosure provides for at least two configurations for processing steel scrap in solid state as an energy-efficient, environmentally friendly alternative to primary and secondary steel processing. As shown, sheet metal can be consolidated (also may be referred to as reconsolidating) as Configuration A, illustrated in FIGS. 2A-2C, and Configuration B, illustrated in FIGS. 3A-3C.

A scrap metal consolidating system (SMC) 10 that is identified as Configuration A includes a container formation portion 12, a scrap metal adding portion 14, and a roll bonding portion 16. A related process 50 is illustrated in FIG. 2C. Starting first with the container formation portion 12 of the system 10, in this embodiment a virgin sheet metal 300 is fed from a coil 101, sometimes referred to as a decoiling action 200, and is formed into a container, as shown a pipe or tube 307, using known techniques for pipe formation from coiled metal. More particularly, the employed technique is a spiral forming technique 207 that results in the pipe 307 having a first, initial, terminal end 307a that is open or closed and a second terminal end 307b that is open and continues to move as the pipe 307 is formed due to the terminal end 307b being constantly changing as the pipe 307 is lengthened during formation. The resulting pipe 307 is configured in a manner that is able to receive scrap metal in a receiving cavity 308 disposed between the two terminal ends 307a, 307b. As used herein, the term pipe can be considered any continuous seamless enclosure geometry.

The pipe formation process can be akin to a spiral-formed manufacturing process, a non-limiting example of which is illustrated in FIG. 2D. The spiral-forming process can involve spiral-welding, among other techniques. As shown, a coil 401 of sheet metal 400 can be bent into a spiral form through angled rolls 402, before being fed into a rolling mill, such as rolls 106 of FIG. 2A. A person skilled in the art will appreciate that a conventional spiral welded pipe can require several welding stations to form such a pipe, but in the spiral forming technique 207 of the present disclosure, it is possible that welding may not be needed at all. The container formation portion 12 of the system 10 is beneficial for a number of reasons, including that a width of the coil 101 and size of the resulting pipe 307 can be independent of each other, making it possible to process large diameter pipes with thin coils and small diameter pipes with large coils.

The scrap metal adding portion 14 of the system 10 provides for the ability to add scrap metal 100 into the formed pipe 307 for eventual combination of the same. The scrap metal 100 can be in a variety of different configurations, sizes, shapes, states, etc. In at least some instances, the scrap metal 100 can be placed in a storage container for eventual use, as designated by storage action 201. The scrap metal 100 and/or the pipe 307 can also be cleaned, as desired, as designated by cleaning action 202. The cleaning action can be either mechanical, e.g., wiping, rubbing, sanding, and so forth, and/or chemical, e.g., via a cleaning agent or a reaction on a surface thereof. Additionally, or alternatively, the scrap metal 100 can be shaped, cut, formed, or otherwise manipulated into different configurations, as well as brushed, sandblasted, or degreased, among other processes known to those skilled in the art for treating scrap metal prior to attempting to consolidate it. Still further, various parameters or properties of the scrap metal 100 can be measured prior to introducing it into the formed pipe 307, such as the compactness of the scrap metal 100 with or without the formed pipe 307. In practice, what can be considered the “inlet metal,” i.e., the scrap metal 100 and the sheet metal 300 from the coil 101 (which can also include the formed pipe 307), may not be fully intact at certain portions of the process, including immediately prior to processing. The combination of the metals 100 and 300 (and thus the formed pipe 307) may include cavities, gaps, etc. However, the “inlet metal” can still be bonded together in the face of such “imperfections” (e.g., cavities, gaps etc.) and can still result in an “output metal” that is a formed or consolidated metal sheet 104. It can still be helpful to measure a compactness ensure the “input metal” is not too porous such that the “output metal” of the resulting consolidation is not less than desirable. To this end, in some embodiments, it can be useful to have an overall density of the “input metal” that is less than the density of the “output metal.” Measuring the compactness can include measuring compactness of at least one of the scrap metal 100, with or without the formed pipe 307, prior to consolidating the scrap metal 100 and the formed pipe 307. Compactness can refer to a measure of gaps in 1 m³ scrap in the furnace and within the container before it is fed into the rolls.

The foregoing notwithstanding, it will be appreciated that one of the benefits of the present techniques is that less energy, effort, and/or time can be spent preparing the scrap metal 100 for consolidation as compared to other techniques currently used for consolidating scrap metal. Thus, such shaping, cutting, forming, brushing, sandblasting, degreasing, and/or otherwise manipulating is not a prerequisite to consolidating the scrap metal 100. In fact, in some embodiments, the scrap metal 100 is not reshaped, cut, reformed, reconfigured, brushed, sandblasted, degreased, or otherwise treated prior to be introduced into the formed pipe 307. In some instances, the system 10 can be designed such that scrap metal (e.g., scrap metal 100) that results from a process is directly fed into the formed pipe 307, possibly foregoing the storage action 201 and/or cleaning action 202, although it can be beneficial to clean and/or store the scrap metal 100 prior to introducing it to the formed pipe 307.

The scrap metal 100, as shown after storing and cleaning it at actions 201 and 202, respectively, can be mixed with the formed pipe 307, at mixing action 203. The scrap metal 100 can be introduced into the pipe 307 formed by the virgin sheet metal 300 using any techniques known to those skilled in the art for adding material into a cylinder or other shape having a closed end, including but not limited to a funnel or otherwise pouring the scrap metal 100 into the pipe 307. As shown in FIG. 2B, a cross-section of the encapsulating geometry, i.e., the pipe 307, and the thickness of the sheet metal 300 can be adaptable to rolling mill and scrap requirements. Beneficially, they are not limited by commercial pipe standards and/or limitations. Additionally, by utilizing a continuous process for forming the pipe 307, the process itself can also be continuous, providing robustness and consistency over an extended period of time to consolidate scrap metal.

In conjunction with adding the scrap metal 100 into the pipe 307, one or more other materials, such as gas 102, can be introduced into the pipe 307, for example to provide or enhance properties of the scrap metal 100, the sheet metal 300′, and thus a formed sheet 104 that results from this process. As shown, in some embodiments this may include adding argon (Ar), nitrogen (N₂), and/or other gases (typically non-oxygen gases) capable of helping to displace oxygen disposed in the cavity of the formed pipe 307. The gas can be added by a gas injector or other known mechanisms for injecting gas to a desired location.

The formed geometry of the pipe 307 can encapsulate the scrap metal 100 and enable it to be fed in between opposed rolls 106 of the roll bonding portion 16 of the system 10. Prior to introducing the combination of the pipe 307 and scrap metal 100 into the rolls 106, the terminal ends 307a, 307b of the pipe 307 can be sealed using techniques known to those skilled in the art. This can help minimize an amount of oxidation that occurs during the roll bonding process. In conjunction with the feeding of the combination of the pipe 307 and scrap metal 100 into the rolls 106, heat 103 can be applied to the combined pipe 307 and scrap metal 100 prior to and/or in conjunction with feeding the encapsulated scrap metal 100 and pipe 307 into the rolls 106. Heating the metal helps create the desired bonding between the scrap metal 100 and the pipe 307, fusing various pieces of scrap metal together, as well as fusing the scrap metal 100 and the pipe 307 together. Alternatively, or additionally, one or both of the scrap metal 100 and/or the sheet metal 300 can be heated at any point during the process prior, during a rolling action 204, and/or after the rolling action 204, e.g., heating the consolidated metal sheet 104 to form a hot rolled coil. For example, one or both of the scrap metal 100 and/or the sheet metal 300 can be heated by way of a batch annealing furnace prior to or as part of an initial portion of the process 50. Alternatively, or additionally, the scrap metal 100 and/or the sheet metal 300 can be heated in a continuous heating furnace during the process 50. After the rolling action 204, the consolidated metal sheet 104 can be cooled down to a lower temperature immediately, e.g., within about one (1) minute, within about 30 seconds, within about 15 seconds, within about ten (10) seconds, within about five (5) seconds, and/or within about one (1) second, or, alternatively, kept at the hot rolling temperature for a given period if needed and/or desired. One circumstance in which the consolidated metal sheet 104 can be maintained at the hot rolling temperature or processing temperature can be to facilitate bonding due to the elevated temperature benefiting bonding. In at least some such embodiments, the consolidated metal sheet 104 can be kept at the processing temperature for a time period approximately in a range of about zero (0) hours to about one (1) hour, or approximately in a range of about one (1) minute to about one (1) hour, among other time periods provided for herein or otherwise understood by a person skilled in the art, in view of the present disclosures.

After performing the rolling action 204 with the rolls 106, also referred to as a hot rolling action, one or more finishing processes, as designated by action 205, can be performed on the consolidated metal sheet 104 that includes the scrap metal 100 and the sheet metal 300. A person skilled in the art will appreciate various finishing processes that can be performed, including but not limited to cold forming, flattening, surface treatment of the consolidated metal sheet 104, and/or heating of the consolidated metal sheet 104 to form a hot rolled coil, as mentioned above.

The system 10 enables a robust process that provides mechanical stability and creates a practical low-O₂ atmosphere during mechanical transformation, limiting O₂ inlet due to encapsulation. The low-O₂ atmosphere can be helpful for the longevity of bonding between the scrap metal 100 and the sheet metal 300 of the pipe 307. The resulting sheet 104, is a bonded sheet that includes the scrap metal 100, the sheet metal 300, and enhancements to properties resulting at least from the addition of the gas 102 and/or the finishing action 205.

A scrap metal consolidating system 10′ identified as Configuration B also includes a container formation portion 12′, a scrap metal adding portion 14′, and a roll bonding portion 16′. A related process 50′ is illustrated in FIG. 3C. The scrap metal adding portion 14′ and roll bonding portion 16′ of the system 10′ are akin to the equivalent portions for the system 10, and thus, aspects of the same may not be fully described herein. Further, to the extent portions of the system 10′ are labeled with reference numerals but not identified and/or fully described herein, their labeling with common reference numerals enable a person skilled in the art to understand how such components of the system 10′ operate similar to like components of the system 10.

For the container formation portion 12′ of the system 10′, a virgin sheet metal 300′ is fed from a coil 101′, sometimes referred to as a decoiling action 200′, and is formed into a container, as shown a pipe or tube 307′, using a longitudinal forming technique 207′. The technique 207′ results in the pipe 307′ having a first, initial, terminal end 307a′ that is open or closed and a second terminal end 307b′ that is open and continues to move as the pipe 307′ is formed due to the terminal end 307b′ being constantly changing as the pipe 307′ is lengthened during formation. The resulting pipe 307′ is configured in a manner that is able to receive scrap metal in a receiving cavity 308′ disposed between the two terminal ends 307a′, 307b′.

The pipe formation process can be akin to a longitudinal manufacturing process, a non-limiting example of which is illustrated in FIG. 3D. A coil (not shown) of sheet metal 400′ can be bent into a circular form through guiding pressure rolls 402′, before being fed into a rolling mill, such as rolls 106 of FIG. 2A. A person skilled in the art will appreciate that a conventional longitudinal welded pipe can require a complex continuous welding station, but in the longitudinal forming technique 207′ of the present disclosure, it is possible that welding may not be needed at all. The container formation portion 12′ of the system 10′ is beneficial for a number of reasons, including its higher processing speed and simplicity as compared to the system 10 of Configuration A.

Similar to the system 10 of FIGS. 2A-2C, the scrap metal adding portion 14′ of the system 10′ provides for the ability to add scrap metal 100′ into the formed pipe 307′ for eventual combination of the same. A storage action 201′ and/or a cleaning action 202′ are possible, as is possible shaping, cutting, forming, brushing, sandblasting, degreasing, manipulating, and/or otherwise treating the scrap metal 100′, though, as with the system 10, a benefit of the system 10′ is that such shaping, cutting, forming, brushing, sandblasting, degreasing, manipulating, and/or otherwise treating actions is not a prerequisite to consolidate the scrap metal 100′. Likewise, compactness of one or both of the scrap metal 100′ and/or the formed pipe 307′ can be measured during the process, prior to compressing it with rolls 106′.

Also similar to the system 10 of FIGS. 2A-2C, the scrap metal 100′ can be mixed with the formed pipe 307′, at mixing action 203′. The scrap metal 100′ can be introduced to the pipe 307′ in ways described above or otherwise appreciated by those skilled in the art.

Further, in at least some embodiments, a gas 102′ (e.g., Ar or N₂) can be introduced into the pipe 307′, which can enhance properties of the scrap metal 100′, the sheet metal 300′, and thus a formed sheet 104′ that results from this process.

Likewise, the formed geometry of the pipe 307′ can encapsulate the scrap metal 100′ and enable it to be fed in between opposed rolls 106′ of the roll bonding portion 16′ of the system 10′. Prior to introducing the combination of the pipe 307′ and scrap metal 100′ into the rolls 106′, the terminal ends 307a′, 307b′ of the pipe 307′ can be sealed using techniques known to those skilled in the art. This can help minimize the amount of oxidation that occurs during the roll bonding process. In conjunction with the feeding of the combination of the pipe 307′ and scrap metal 100′ into the rolls 106′, heat 103′ can be applied to the combined pipe 307′ and scrap metal 100′ prior to and/or in conjunction with feeding the encapsulated scrap metal 100′ and pipe 307′ into the rolls 106′. As discussed above, in at least some embodiments, a batch annealing furnace and/or a continuous heating furnace can be used to heat one or both the scrap metal 100′ and the sheet metal 300′ during the process 50′.

After performing a hot rolling action 204′ with the rolls 106, one or more finishing processes, as designated by action 205′, can be performed on the consolidated metal sheet 104′ that includes the scrap metal 100′ and the sheet metal 300′. A person skilled in the art will appreciate various finishing processes that can be performed.

Unlike existing roll bonding techniques, in which a thickness reduction of the resulting sheet is about 50%, i.e., it is deformed by about 50%, the present techniques produce a resulting sheet that having a thickness reduction of about 17%, i.e., it is deformed by about 17%.

A person skilled in the art will appreciate that while the container formation portion 12, 12′ of the systems 10, 10′ are directed to techniques for manufacturing pipes, the systems 10, 10′ and associated methods are not necessarily limited to forming a pipe or tube shape. Other shapes and containers can be manufactured while achieving the same purpose. More generally the container formation portion 12, 12′ is directed towards forming a container having a closed end, e.g., the terminal ends 12a, 12a′, and an open end, e.g., the terminal ends 12b, 12b′, for receiving scrap metal 100, 100′ therein. The shape, configuration, size, and other parameters of the pipe 307, 307′, or other container produced by way of the container formation portion 12, 12′, can be optimized as desired based on, at least in part, the tooling of the systems 10, 10′, the desired characteristics and properties of the to-be-produced sheet 104, 104′, and other factors understood by those skilled in the art in view of the present disclosures.

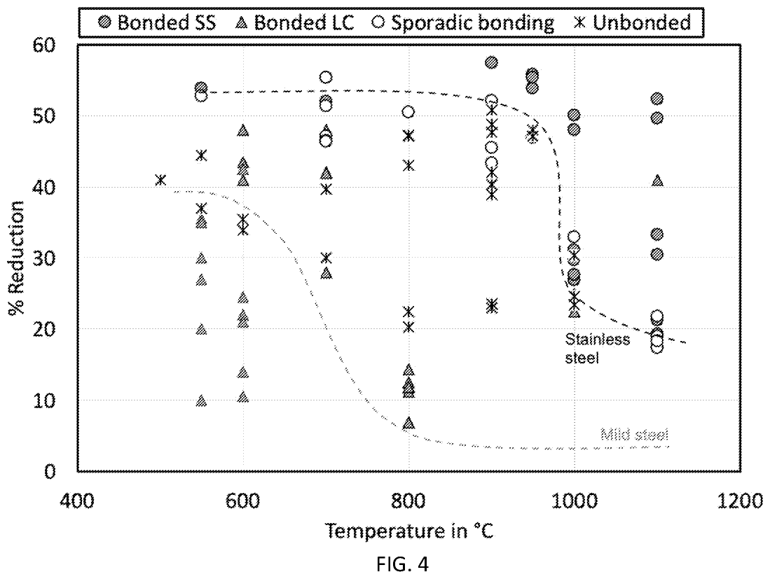

The processing method and the process windows for AISI 1008 mild steel and SS304 stainless steel can be determined in terms of rolling temperature and reduction degree to determine optimal SMC performance. FIG. 4 illustrates the effect of processing conditions (i.e., temperature, reduction degree % R) on roll bonding trials following Configurations A and B. Specifically, FIG. 4 illustrates a roll bonding processing map for mild steel (▴) and stainless steel (●) trials in terms of thickness reduction and hot rolling temperature. As shown, filled in shapes represent successful bonding trials, (*) denotes unsuccessful bonding attempts, and unfilled shapes show processing conditions where bonding is unstable (i.e., partially observed, but not enough for producing an intact sample). For each material, the region above the dashed line is where successful roll bonding is expected.

Increasing either temperature or %-reduction can have a positive effect on bonding success, but these parameters may not have a linear effect. For both, up to the temperature limit, the amount of deformation is the limiting factor for successful bonding. After passing this temperature threshold, the required %-reduction for bonding can decrease significantly, giving the processing boundary an inverse s-curve shape. As shown, both stainless steel (SS) and mild steel (LC) samples can exhibit this inverse s-curve behavior. In some embodiments, it is possible to bond stainless steel samples at a thickness reduction of about 20% to about 25% if the temperature is at least 1000° C. For processing temperatures below 1000° C., the thickness reduction can increase to about 50% to about 55% for robust bonding. An unstable bonding region for the material can also be defined, where partial bonding can be observed but is not enough to keep the roll-bonded stack together. For stainless steel, the unstable bonding region can include an about 20% to about 25% reduction if the processing temperature is above 1000° C. and an about 45% to about 55% reduction if the temperature is lower.

As shown in FIG. 4, the mild steel samples (LC) can have similar processing characteristics with different process boundaries. For mild steel, the %-reduction threshold for bonding drops from 40% to 7% by increasing the rolling temperature from 600° C. to 800° C. It may still be possible to bond mild steel stacks together with a 7% thickness reduction when the processing temperature increases to 800° C. Even at processing temperatures below 600° C., mild steel samples can be bonded with a thickness reduction of 40%. For stainless steel specimens, on the other hand, the drop in %-reduction threshold can be from about 55% to about 25%, taking place at 1000° C. It will be appreciated that the change in bonding behavior can be more sudden in stainless steel compared to the gradual decline in bonding resistance of mild steel. The difference in the behavior of native oxides can explain the different responses of these materials. The thin layer of mechanically unstable iron oxide on the mild steel surface can be easily dispersed by the compressive loading of the roll bonding process, which can allow for dislocation rearrangement (i.e., bonding) to occur at an earlier temperature. In stainless steel, however, a more mechanically stable chromium oxide layer can demand additional temperature rise to allow for a dislocation realignment.

The present observations can differ from conventional roll-bonding practice in at least two aspects. First, hot roll bonding practice can recommend a temperature range above half of the melting temperature and an about 60% reduction in a single pass. In the present embodiments, both steel grades can be bonded at lower temperatures or %-reductions. Although it should be noted that roll bonding practice can focus on processing composite laminates, the present embodiments can aim for an ideal bonding condition throughout the bonding interface, with successful bonding being defined as intact structures.

A person skilled in the art will recognize that it may be possible to optimize the metal consolidation process at a lower CO₂ burden for both steel grades by decreasing the pre-heating temperature at least because pre-heating can be a major energy consumer. Below the threshold temperature, however, consolidation may demand a significantly higher %-reduction, and hence more energy and larger equipment, which can diminish the gains obtained by decreasing the processing temperature.

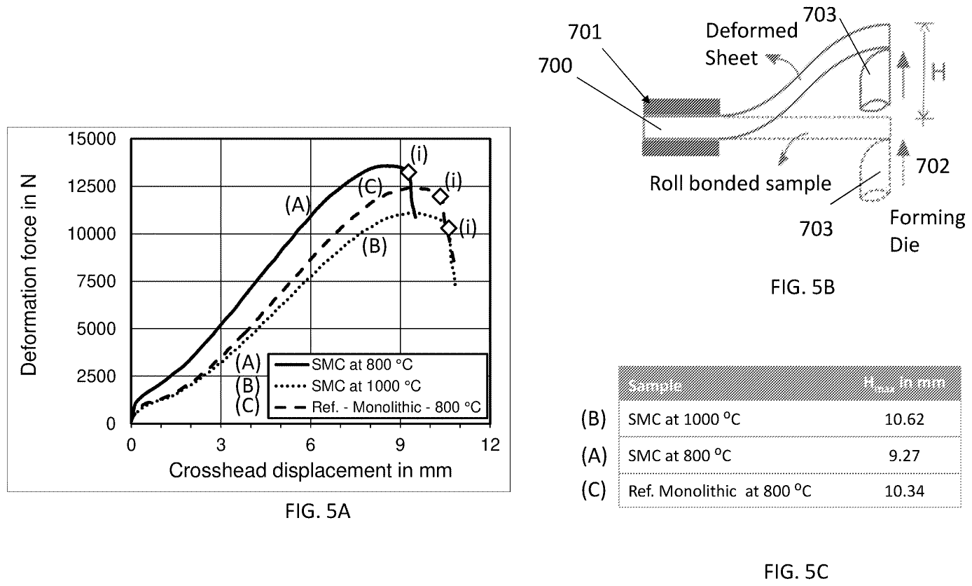

FIGS. 5A-5C illustrate the formability response of roll-bonded mild steel specimens under equibiaxial tension. The deformation response of three specimens can be determined based on the fracture height. FIG. 5A shows the crosshead displacement with respect to a reaction force for three samples: (1) roll-bonded sheet at about 800° C. (on the processing map border) (A); (2) roll-bonded sheet at about 1000° C. (in the robust roll-bonding region) (B); and (3) monolithic mild steel sample at a similar thickness processed at about 800° C. (C), with each fracture point being noted by (i). As shown in FIG. 5B, limit dome height (LDH) can be a material characteristic used by the industry for evaluating the formability of a sheet metal. As shown, a circular metal sheet 700 can be clamped on its perimeter (thick lines) 701, and subjected to an increasing out-of-plane deformation (the arrow direction) 702 at its center by a forming die 703. The final height H, where the sheet 700 eventually fractures, was recorded, with a high H value showing a high formability performance. The table of FIG. 5C shows the result of this test for a crosshead height at fracture (Hmax) for three specimens (two roll bonded sheets processed at different temperatures, and a reference single layer commercial steel). It will be appreciated that a low H-value for roll bonded samples is expected if a bonding mechanism hinders the forming performance. The H-value of both roll bonded samples and the reference single layer sample were determined to be comparable. Specifically, the monolithic reference sample (C) fractured at a crosshead distance of about 10.34 mm, whereas the roll-bonded sample at about 800° C. (A) and about 1000° C. (B) failed at about 9.27 mm and about 10.62 mm crosshead displacements, respectively. The fluctuations in the force response can be related, at least in part, to the variance in the sample thickness after rolling because the roll gap was kept constant during the experimental campaign, while the yield stress, and hence thickness, depend on the processing temperature.

### Mobile Consolidation Unit

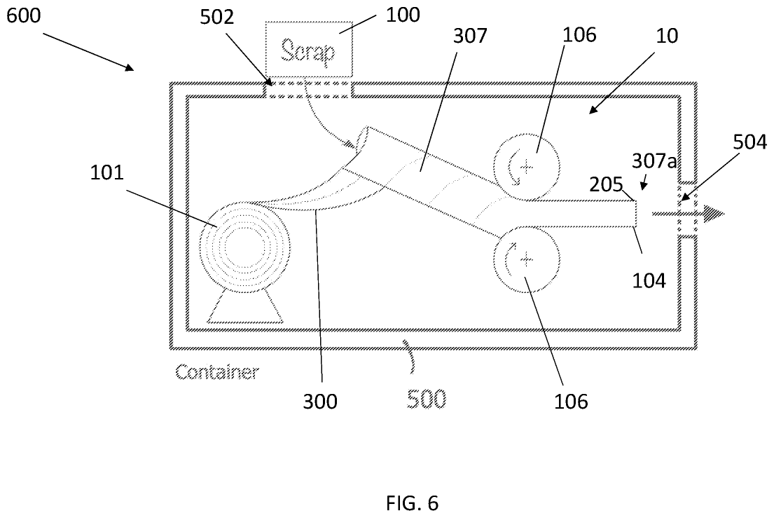

FIG. 6 illustrates an example of a mobile consolidation unit 600 in which Configuration A of FIGS. 2A-2C is disposed and operated inside a shipping container 500. Configuration B of FIGS. 3A-3C can likewise be used in lieu of Configuration A in an alternative configuration of a mobile consolidation unit. The unit can be considered a “rolling mill in a box.” As shown, FIG. 6 includes the scrap metal consolidating system 10 of Configuration A installed and operated in the shipping container 500. The operations performed in the container 500 can include, for example, pipe bending and/or rolling, whereas operations such as scrap feeding, heating, and/or recoiling can be performed outside the container 500. In use, the scrap metal 100 can be introduced via a first opening 502 into the container 500 as disclosed in the embodiments above, with the consolidated metal sheet 104 passing out of the container through a second opening 504. The consolidated metal sheet 104 can be heated if needed after it leaves the container 500 before or after recoiling. The scrap metal 100 can be introduced into the pipe 307 formed by the virgin sheet metal 300 using any techniques known to those skilled in the art for adding material into a cylinder or other shape having a closed end, including but not limited to a funnel or otherwise pouring the scrap metal 100 into the pipe 307. The scrap metal 100 can be heated by way of a batch annealing furnace outside the shipping container 500 prior to or as part of an initial portion of the roll bonding process. This configuration can limit the dimensions of SMC machinery to a shipping container, with an advantage being that the configuration provides mobility. For example, traditionally, the sheet metal scrap has been agglomerated at scrap yards, sorted out, and sent to recycling furnaces. A mobile SMC unit, such as the unit 600 shown in FIG. 6, can transform high-quality, sorted scrap into commercial sheet metal on the manufacturer site, eliminating the need to agglomerate the scrap and the risk of contamination by other materials at a scrap yard.

Examples of the above-described embodiments can include the following:
1. A method of manufacturing, comprising:
   configuring sheet metal into a container having an open or closed first terminal end and a second open terminal end, with a receiving cavity formed therebetween;
   placing scrap metal in the receiving cavity of the container such that the scrap metal is disposed in the container;
   feeding the container having the scrap metal disposed therein towards a plurality of rolls; and
   operating the plurality of rolls to roll bond the sheet metal of the container and the scrap metal into a consolidated metal sheet.
2. The method of claim 1, further comprising:
   heating at least one of the scrap metal, the sheet metal, or the plurality of rolls at least one of prior to or during operation of the plurality of rolls to a temperature to roll bond the sheet metal of the container and the scrap metal into a consolidated metal sheet; and
   maintaining the temperature for a time period that is in approximately a range of about one minute to about one hour.
3. The method of claim 2, wherein the temperature is at least about 700° C.
4. The method of any of claims 1 to 3, further comprising:
   introducing a gas to the receiving cavity of the container.
5. The method of claim 4, wherein the gas comprises at least one of argon, nitrogen, or a non-oxygen gas.
6. The method of any of claims 1 to 5, further comprising sealing the second open terminal end prior to feeding the container having the scrap metal disposed therein into the plurality of rolls.
7. The method of any of claims 1 to 6, wherein configuring sheet metal into a container further comprises performing a spiral-formed manufacturing process.
8. The method of any of claims 1 to 6, wherein configuring sheet metal into a container further comprises performing a longitudinal manufacturing process.
9. The method of any of claims 1 to 8, wherein the container comprises a pipe.
10. The method of any of claims 1 to 9, further comprising storing the scrap metal prior to placing the scrap metal in the receiving cavity of the container.
11. The method of any of claims 1 to 10, further comprising at least one of mechanically or chemically cleaning at least one of the scrap metal or the container prior to placing the scrap metal in the receiving cavity of the container.
12. The method of any of claims 1 to 11, further comprising measuring a compactness of the scrap metal or the container prior to feeding the container having the scrap metal disposed therein into the plurality of rolls.
13. The method of any of claims 1 to 12, further comprising finishing the consolidated metal sheet.
14. A consolidated metal sheet formed by any of the methods of claims 1 to 13.
15. A system for consolidating scrap metal, comprising:
   a container formation portion configured to produce a container from a sheet metal, the container having an open or closed first terminal end and a second open terminal end, with a receiving cavity formed therebetween;
   a scrap metal adding portion configured to add scrap metal into the receiving cavity of the formed container; and
   a roll bonding portion configured to roll bond the scrap metal with the formed container using a plurality of rollers.
16. The system of claim 15, further comprising a heater configured to heat at least one of the scrap metal, the sheet metal, or the plurality of rollers.
17. The system of claim 15 or 16, further comprising a gas injector configured to introduce gas into the receiving cavity of the formed container.
18. The system of any of claims 15 to 17, wherein the container formation portion comprises a coil of the sheet metal.
19. The system of claim 18, wherein the container formation portion is configured to operate as a spiral-formed manufacturing process.
20. The system of claim 18, wherein the container formation portion is configured to operate as a longitudinal manufacturing process.
21. The system of any of claims 15 to 20, further comprising:
   a shipping container in which the container formation portion and the roll bonding portion are disposed.

One skilled in the art will appreciate further features and advantages of the disclosures based on the provided for descriptions and embodiments. Accordingly, the inventions are not to be limited by what has been particularly shown and described. All publications and references cited herein are expressly incorporated herein by reference in their entirety.

Some non-limiting claims are provided below.

1. A method of manufacturing, comprising:
configuring sheet metal into a container having an open or closed first terminal end and a second open terminal end, with a receiving cavity formed therebetween;
placing scrap metal in the receiving cavity of the container such that the scrap metal is disposed in the container;
feeding the container having the scrap metal disposed therein towards a plurality of rolls; and
operating the plurality of rolls to roll bond the sheet metal of the container and the scrap metal into a consolidated metal sheet.

2. The method of claim 1, further comprising:
heating at least one of the scrap metal, the sheet metal, or the plurality of rolls at least one of prior to or during operation of the plurality of rolls to a temperature to roll bond the sheet metal of the container and the scrap metal into a consolidated metal sheet; and
maintaining the temperature for a time period that is in approximately a range of about one minute to about one hour.

3. The method of claim 2, wherein the temperature is at least about 700° C.

4. The method of claim 1, further comprising:
introducing a gas to the receiving cavity of the container.

5. The method of claim 4, wherein the gas comprises at least one of argon, nitrogen, or a non-oxygen gas.

6. The method of claim 1, further comprising sealing the second open terminal end prior to feeding the container having the scrap metal disposed therein into the plurality of rolls.

7. The method of claim 1, wherein configuring sheet metal into a container further comprises performing a spiral-formed manufacturing process.

8. The method of claim 1, wherein configuring sheet metal into a container further comprises performing a longitudinal manufacturing process.

9. The method of claim 1, wherein the container comprises a pipe.

10. The method of claim 1, further comprising storing the scrap metal prior to placing the scrap metal in the receiving cavity of the container.

11. The method of claim 1, further comprising at least one of mechanically cleaning or chemically cleaning at least one of the scrap metal or the container prior to placing the scrap metal in the receiving cavity of the container.

12. The method of claim 1, further comprising measuring a compactness of the scrap metal or the container prior to feeding the container having the scrap metal disposed therein into the plurality of rolls.

13. A consolidated metal sheet formed by the method of claim 1.

14. A system for consolidating scrap metal, comprising:
a container formation portion configured to produce a container from a sheet metal, the container having an open or closed first terminal end and a second open terminal end, with a receiving cavity formed therebetween;
a scrap metal adding portion configured to add scrap metal into the receiving cavity of the formed container; and
a roll bonding portion configured to roll bond the scrap metal with the formed container using a plurality of rollers.

15. The system of claim 14, further comprising a heater configured to heat at least one of the scrap metal, the sheet metal, or the plurality of rollers.

16. The system of claim 14, further comprising a gas injector configured to introduce gas into the receiving cavity of the formed container.

17. The system of claim 14, wherein the container formation portion comprises a coil of the sheet metal.

18. The system of claim 17, wherein the container formation portion is configured to operate as a spiral-formed manufacturing process.

19. The system of claim 17, wherein the container formation portion is configured to operate as a longitudinal manufacturing process.

20. The system of claim 14, further comprising:
a shipping container in which the container formation portion and the roll bonding portion are disposed.
